(19) United States
(12) Patent Application Publication
(10) Pub. No.: US 2007/0085061 A1
(43) Pub. Date: Apr. 19, 2007

(54) Conductivity enhancement of conductive polymers by solvent exposure

(76) Inventors: Delwin Lerone Elder, Allentown, PA (US); Xuezhong Jiang, Fogelsville, PA (US); Lloyd Mahlon Robeson, Macungie, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 11/580,505

(22) Filed: Oct. 13, 2006

Related U.S. Application Data
(60) Provisional application No. 60/726,853, filed on Oct. 14, 2005.

(51) Int. Cl. H01B 1/12

(52) U.S. Cl. 252/500

(57) ABSTRACT

The electrical conductivity of thin films of transparent conducting polymers such as poly(3,4-ethylenedioxythiophene)/polystyrene sulfonic acid (PEDOT/PSS) can be increased greatly by exposure to certain polar organic solvents, aqueous/organic solutions, and aqueous/organic or organic solutions containing additives such as oxidative dopants, monomers, organic compounds, or combinations thereof. The transparency of the film in the visible region of the spectrum is maintained after treatment to enhance conductivity. The conductivity of films of transparent conducting polymers based on poly(thienothiophenes) such as poly(thieno[3,4-b]thiophene)/PSS (PTT/PSS) and poly(thieno[3,4-b]thiophene)/fluoropolymeric acid is altered to much less of a degree by analogous solvent treatment, or by direct solvent addition into PTT dispersions. The invariability of PTT based conductive polymer such as PTT/PSS and PTT/fluoropolymeric acid to solvent treatment is desirable given the solvent processing required for using a conducting polymer as a hole injection layer in light emitting diodes, and as functional layers in other organic electronics. In a printing method, polar or high boiling point solvents are frequently used to tune the drying process of the printed dispersions or solutions. A conductive polymer such as PTT whose conductivity is insensitive to the solvent used to tune the process offers a significant advantage for ink formulation of both the PTT hole injection layer and the subsequent organic layers, such as hole transporting/electron blocking layer and light emitting layer.

This application claims the benefit of Provisional Application No. 60/726,853, filed on Oct. 14, 2005. The disclosure of the Provisional Application is hereby incorporated by reference.

### FIELD OF THE INVENTION

The instant invention relates to a process for increasing the electrical conductivity of a polymer film, which has been cast (e.g., from aqueous dispersion or solution), by directly contacting the film with at least one organic solvent, solvent mixtures, or organic solvents with additives, and then removing all or substantially all of the solvent by rinsing, heating, vacuum treatment, or other methods. The instant invention also relates to improving certain characteristics of poly(thienothiophene) (PTT) containing films by contacting with at least one solvent and without substantially increasing the conductivity of the film. The instant invention also relates to improving certain characteristics of polythienothiophene films derived from a polythienothiophene dispersion that is formulated with organic solvents.

### BACKGROUND OF THE INVENTION

Polythiophenes and substituted polythiophenes have conductive properties which may be controlled by the degree of oxidation (p-doping). Poly(3,4-ethylenedioxythiophene) doped with polystyrenesulfonic acid (PEDOT/PSS) is one of the most popular conducting polymers. PEDOT in its neutral undoped state is insoluble in all common solvents and oxidizes quickly in air. For ecological reasons, it is preferable to cast a conducting polymer film from aqueous solution rather than an organic solvent that may be flammable or toxic. It is also advantageous to use aqueous solutions to obtain solvent orthogonality when spin casting multiple layers of films. That is, when solvent-casting multiple layers of films, it is desirable to use a solvent that does not wash away the previous layer. PEDOT/PSS is an example of a doped conducting polymer that may be chemically synthesized as a water dispersion that is stable for months and cast into uniform, conductive films. However, the conductivity of conventional PEDOT/PSS films is typically insufficient for many uses.

Conventional methods for enhancing the conductivity of waterborne polymers all typically pertain to combining solvents or additives with the waterborne dispersion, and then casting a film. For example, it is well known that adding sorbitol or NMP to a PEDOT/PSS dispersion can increase the conductivity of the film after annealing. However, not all solvents or additives will be compatible with the aqueous dispersion or solution and may cause it to destabilize, greatly reducing the shelf life. Some solvents or additives can cause the formation of discontinuous or cracked films, reducing the surface coverage, film uniformity, and thus conductivity. Therefore, it is desirable to have an alternative method to increase the conductivity of polymer films that avoids adding solvent/additives to the solution or dispersion of conducting polymer before casting.

### BRIEF SUMMARY OF THE INVENTION

One aspect of the instant invention solves problems associated with conventional processes by exposing a previously formed film or layer to at least one solvent for a time and under conditions sufficient to improve the conductivity of the underlying film or layer. By “solvent” as used in the instant invention it is meant to refer to compounds or compositions that comprise at least one organic material, and wherein the conductive polymer has limited, if any, solubility in the solvent.

The instant invention comprises a process for increasing the conductivity of a polymer film, which has been cast from aqueous dispersion or solution, by directly exposing the film to at least one organic solvent, solvent mixtures, or organic solvents with additives, and then removing all or substantially all of the solvent by rinsing, heating, vacuum treatment, or other methods. By removing substantially all of the solvent, the film or film surface is substantially free of solvent.

One aspect of the invention relates to improving the conductivity of PEDOT/PSS films. By using the process of the invention, the conductivity of poly(3,4-ethylenedioxythiophene)/polystyrene sulfonic acid (PEDOT/PSS) containing films can be increased by over two orders of magnitude to greater than about 100 S/cm. The transparency of the film in the visible region of the spectrum is maintained after the inventive process to enhance conductivity. The conductivity improvement of polymer films comprising poly(thienothiophenes), such as poly(thieno[3,4-b]thiophene)/PSS (PTT/PSS) and poly(thieno[3,4-b]thiophene)/ fluoropolymeric acid (e.g., a perfluorosulfonic acid polymer such as sold commercially as Nafion®), by the inventive process is typically less than a factor of about 20.

The inventive method can be used to enhance the conductivity of polymers used to prepare antistatic coatings, electrodes for capacitors, hole injection/transport layer or electrodes for light-emitting diodes or photovoltaic devices, optically transparent conductors for display devices, electromagnetic radiation shielding, wires for microelectronics, among other applications of conductive materials.

Another aspect of the invention relates to treating a poly(thienothiophene) based conductive polymer films, such as PTT/PSS and PTT/Nafion® film without substantially increasing the conductivity (e.g., the conductivity of a PTT/PSS film remains less than about 1 S/cm). PTT/PSS films and methods for forming such films is disclosed in U.S. Patent Application Publication No. US2005-0151122-A1; and U.S. patent application Ser. No. 11/240,573 (filed on Oct. 03, 2005); both hereby incorporated by reference. The conductivity of PTT/PSS films is much less effected by solvent treatments or solvent addition; the maximum conductivity change is typically less than a factor of about 10. The invariability of PTT/PSS to solvent treatment is desirable given the solvent processing required for using a conducting polymer as a hole injection layer in light emitting diodes, and functional layers in other organic electronics. Conductive polymers have been found also to be able to improve the performance of organic material based devices. For example, in organic or polymer based light emitting diodes (OLEDs or PLEDs), conductive polymers with desired conductivities (10⁻⁶ to 10⁻¹ S/cm) can be used as the hole injection layer to greatly improve the device efficiency and stability (lifetime), while lower the device operating voltage. For high resolution and low cost fabrication of such devices, printing methods such as ink jet printing, gravure printing, screening printing can be used. To formulate the conductive polymer inks for such printing methods, solvents with polarity or high boiling point are frequently added into the conductive polymer dispersions to adjust/control the drying process, so as to form uniform film of the conductive polymer after drying. Ideally, the conductivity of the conductive polymers should not change after the ink formulation. However, the conductivity of PEDOT based conductive polymers changes dramatically after the addition of polar solvents, which can make it difficult to formulate PEDOT based conductive polymers for PLEDs or OLEDs hole injection layer applications. For example, the much increased conductivity may cause a conductive polymer that is designed for passive matrix displays to cause crosstalk issue. However, the conductivity of PTT based conductive polymers is almost independent of the solvent that is used to formulate the ink. This feature greatly facilitates the ink formulation, allowing for a wide range of solvents to be chosen for the desired drying process and film uniformity. Therefore, PTT based conductive polymers are ideally suited for printing methods. If desired, the PTT/PSS film could be treated with a suitable solvent in order to improve the film smoothness and uniformity.

### BRIEF DESCRIPTION OF SEVERAL VIEWS OF THE DRAWINGS

FIG. 1 illustrates an absorbance spectrum of a PEDOT/PSS system before and after exposure to the inventive process.

FIG. 2a illustrates the conductivity of a PEDOT/PSS system after exposure to iodine.

FIG. 2b illustrates the conductivity of a PEDOT/PSS system after exposure to iodine.

FIG. 3 illustrates the conductivity of PEDOT/PSS after exposure to a solution comprising formamide and water.

### DETAILED DESCRIPTION OF THE INVENTION

The instant invention relates to a process for increasing the electrical conductivity of polymeric film (e.g., a film which was cast from aqueous dispersion or solution), by directly contacting the film with a solution comprising at least one organic solvent, solvent mixtures, or organic solvents with additives. After contacting, all or substantially all of the solvent by rinsing, heating, vacuum treatment, among other methods.

In one aspect of the invention, the solution used in the inventive process can comprise any suitable organic solvent that is soluble in water (at 25 C and 1 atm) to greater than or equal to 1 wt %. Solvents with a dielectric constant greater than about 6 are typically useful. Solvents with a boiling point greater than about 100 C are also typically useful. Examples of suitable solvents comprise at least one member selected from the group consisting of ethylene glycol, formamide, 2,2,3,3-tetrafluoro-1-propanol, ethylene carbonate, acetic acid, dimethylsulfoxide (DMSO), pyridine, N-methylpyrrolidinone (NMP), N,N-dimethyacetamide (DMAc), acetonitrile, tetrahydrofuran (THF), isopropanol, and methanol.

In another aspect of the invention, the solution employed in the inventive process can comprise a composition comprising at least two organic solvents, wherein at least one of the solvents is at least partially soluble in water (at 25 C and 1 atm) to greater than or equal to about 1 wt %. The amount of the solvent that is soluble in water (at 25 C and 1 atm) may be from about 0.1 vol % to about 99.9 vol %. Solvents with a dielectric constant greater than about 6 can be used in the inventive process. Solvents with a boiling point greater than about 100 C can also be used in the inventive process. Examples of suitable solvents comprise at least one member selected from the group consisting of ethylene glycol, formamide, 2,2,3,3-tetrafluoro-1-propanol, ethylene carbonate, acetic acid, dimethylsulfoxide (DMSO), pyridine, N-methylpyrrolidinone (NMP), N,N-dimethyacetamide (DMAc), acetonitrile, tetrahydrofuran (THF), isopropanol, and methanol.

In another aspect of the invention, the solution employed in the inventive process comprises water and at least one organic solvent wherein the organic solvent is at least partially soluble in water (at 25 C and 1 atm) to greater than or equal to about 1 wt %. The water content of the solution may be from about 1 vol % to about 99 vol %. Organic solvents with a dielectric constant greater than about 6 can be used. Solvents with a boiling point greater than about 100 C can also be used. Examples of suitable solvents comprise at least one member selected from the group consisting of ethylene glycol, formamide, 2,2,3,3-tetrafluoro-1-propanol, ethylene carbonate, acetic acid, dimethylsulfoxide (DMSO), pyridine, N-methylpyrrolidinone (NMP), N,N-dimethyacetamide (DMAc), acetonitrile, tetrahydrofuran (THF), isopropanol, and methanol.

In another aspect of the invention, the solution employed in the inventive process comprises at least one organic solvent and at least one chemical oxidant. The organic solvent comprises any suitable solvent that is soluble in water (at 25 C and 1 atm) to greater than or equal to about 1 wt %. Solvents with a dielectric constant greater than 6 can be used. Solvents with a boiling point greater than 100 C can also be useful. Examples of suitable solvents comprise at least one member selected from the group consisting of ethylene glycol, formamide, 2,2,3,3-tetrafluoro-1-propanol, ethylene carbonate, acetic acid, dimethylsulfoxide (DMSO), pyridine, N-methylpyrrolidinone (NMP), N,N-dimethyacetamide (DMAc), acetonitrile, tetrahydrofuran (THF), isopropanol, and methanol. The chemical oxidant may comprise at least one oxidant or p-dopant. Examples of suitable chemical oxidant comprise at least one member selected from the group consisting of iodine, bromine, iron salts such as FeCl₃, FeBr₃, Fe₂(SO₄)₃, iron(III) p-toluenesul fonate, other iron(III) compounds, ammonium persulfate, AsF₅, and salts or acids of BF₄⁻, SbF₆⁻, PF₆⁻. The chemical oxidant may be from about 0.0001 M to about 1 M in concentration, and typically from about 0.001 to about 0.1 M in concentration. Optionally the solution may contain water in an amount ranging from about 1 vol % to about 99 vol %.

In another aspect of the invention, the solution comprises at least one organic solvent, at least one chemical oxidant, and at least one polymerizable thiophene monomer. The organic solvent can comprise any suitable solvent that is at least partially soluble in water (at 25 C and 1 atm) to greater than or equal to about 1 wt %. Solvents with a dielectric constant greater than about 6 can be used. Solvents with a boiling point greater than about 100 C can also be used. Examples of suitable solvents comprise at least one member selected from the group consisting of ethylene glycol, formamide, 2,2,3,3-tetrafluoro-1-propanol, ethylene carbonate, acetic acid, dimethylsulfoxide (DMSO), pyridine, N-methylpyrrolidinone (NMP), N,N-dimethyacetamide (DMAc), acetonitrile, tetrahydrofuran (THF), isopropanol, and methanol. The chemical oxidant may comprise at least one oxidant or p-dopant selected from the group consisting of iodine, bromine, iron salts such as FeCl₃, FeBr₃, Fe₂(SO₄)₃, iron(III) p-toluenesulfonate, other iron(III) compounds, ammonium persulfate, AsF₅, and salts or acids of BF₄⁻, SbF₆⁻, PF₆⁻. The chemical oxidant may be from about 0.001 M to about 1 M in concentration, and usually from about 0.02 to about 0.2 M in concentration. The polymerizable thiophene monomer can comprise at least one member selected from the group consisting of 3,4-ethylenedioxythiophene, thieno[3,4-b]thiophene, thiophene, 3-alkylthiophenes, and 3,4-dialkylthiophenes. The polymerizable thiophene monomer may be from about 0.001 M to about 1 M in concentration, and usually from about 0.02 to about 0.2 M in concentration. Optionally the solution may comprise water from about 1 vol % to about 99 vol %.

In another aspect of the invention, the solution employed in the inventive process may comprise at least one surfactant or mixtures of surfactants. Examples of suitable surfactants comprise at least one member selected from the group consisting of Igepals, fluorinated ionic surfactants, fluorinated non-ionic surfactants, Zonyl FSO, Zonyl FSO100, Dynol 604 Surfactant, and Surfynol Surfactants. The surfactant or mixture of surfactants may be present from about 0.001 wt % to about 5 wt %.

In further aspect of the invention, the solution employed in the inventive process may comprise at least one adhesion promoter. Examples of adhesion promoters comprise at least one member selected from the group consisting of (3-glycidyloxypropyl)trimethoxysilane and other epoxysilanes, siloxanes, or epoxides. The adhesion promoter may be present from about 0.01 wt % to about 5 wt %.

In one aspect of the invention, the solution used in the inventive process may comprise at least one dihydroxy or polyhydroxy compounds. Examples of suitable compounds comprise sorbitol or arabitol. The polyhydroxy compound may be present from about 0.1 wt % to about 50 wt %.

Solvent solutions can be prepared by using any suitable method for combining the ingredients. Such methods comprising mixing, blending, among other conventional methods.

In one aspect of the invention, the conducting polymer to be treated by the inventive process is cast as a film onto a substrate from an aqueous or partially aqueous solution and dried to remove greater than about 50 wt % of the solvent. The film may be processed by heating in air, nitrogen, or another inert environment. Normally the film is processed at a temperature of about 190 to about 210 C for a period of about 5 to about 10 min in a nitrogen environment. The conductivity of the film can be increased by exposing the film to at least one of the aforementioned solutions for at least about 10 seconds (e.g., about 30 seconds to about 72 hours, and usually about 1 minute to about 1 hour). Exposure may be done by submersing the film, pooling solvent onto the surface of the film, doctor blade coating, exposure to solvent vapors, or other standard techniques. Excess solvent may be optionally removed from the film by rinsing in distilled water for about 1 second to about 1 hr (e.g., about 30 seconds to 1 about minute). If desired, excess solvent may be optionally removed from the film by rinsing in a low boiling solvent such as methanol for about 1 second to about 1 hr, and usually about 30 seconds to about 1 minute. While the solvent can remain on the film surface in order to achieve the results of the instant invention, it is not necessary for the solvent to remain in or on the film to achieve improved conductivity. The film may then be dried by air drying, blow drying, spin drying, heating, applying vacuum, or any combination of these methods to remove substantially all or all of the solvent. Typically, the film is spin dried at about 3000 rpm for about 1 min then dried by heating to about 90 C under nitrogen for about 2 minutes.

If desired, the inventive process can be repeated by exposing the polymer film to the solution multiple times, with an optional rinse and/or drying step between each exposure.

The inventive process can be employed for increasing the conductivity of a film comprising at least one doped substituted polypyrrole, substituted polythiophene, or poly(heterocycle) of the general formula: 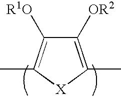
where R₁ and R² independently of one another represent hydrogen, or a C₁₋₁₂ alkyl group or substituted alkyl group, or together form an optionally substituted C₁₋₁₂ alkylene radical; and X═S, Se, N—H, or N—R, where R is an alkyl group or substituted alkyl group.

In another aspect of the invention, the film comprises poly(3,4-ethylenedioxythiophene)/polystyrene sulfonic acid (PEDOT/PSS).

The inventive process can be employed for treating a doped poly(thienothiophene), substituted poly(thienothiophene), or bicyclic comprising the general formula 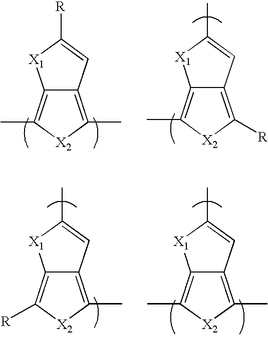
where X₁ and X₂ independently of one another represent O, S, Se, C═O, N—H, P—H, N—R, or P—R where R is H, an alkyl group, or substituted alkyl group.

In another aspect of the invention, the conducting polymer dispersion and film comprises poly(thieno[3,4-b]thiophene)/polystyrene sulfonic acid (PTT/PSS) or poly(thieno[3,4-b]thiophene)/fluoropolymeric acid such as PTT/Nafion®.

In another aspect of the invention, the inventive process increases the conductivity of a film comprising PTT/PSS by a factor of less than about 100 (typically less than a factor of about 20).

In another aspect of the invention, the inventive process comprising adding solvent to PTT based conductive polymer dispersion in water. The conductivity of films cast from such modified dispersions maintains at a level less than 100 (typically less than 20) times of that of films coated from the original dispersion.

Examples of other polymers which can be used to practice the present invention are of substituted and unsubstituted polythiophenes, polypyrroles, polyselenophenes, polythienothiophenes, poly(para-phenylenevinylenes), poly(para-phenylenes), poly(para-phenyleneethynylenes), polyanilines, polyazines, poly(para-phenylene sulfide), polyfurans, polyacetylenes, combinations thereof, and copolymers thereof.

The instant invention is applicable to polymers and polymeric films deposited from an aqueous or partially aqueous dispersion or solution. Polymers may be deposited by spin casting, drop casting, evaporative casting, spraying, rolling, painting, drawing down, printing, stamping, or any other technique for depositing thin films.

In one apect of the invention, the conducting polymer remains substantially transparent in the visible spectral region (400-750 nm) after exposure to the aforementioned solution(s) and rinsing and/or drying.

In another aspect of the invention, the absorbance of a film (normalized to 100 nm thickness) increases by less than a factor of about 5 (e.g., typically less than a factor of about 2 in the visible spectral region (400-750 nm)), after exposure to the aforementioned solution(s) and rinsing and/or drying.

In another aspect of the invention, the absorbance of a film (normalized to 100 nm thickness) is less than about 0.4 (e.g., less than about 0.2 in the visible spectral region (400-750 nm)), after exposure to the aforementioned solutions and rinsing and/or drying.

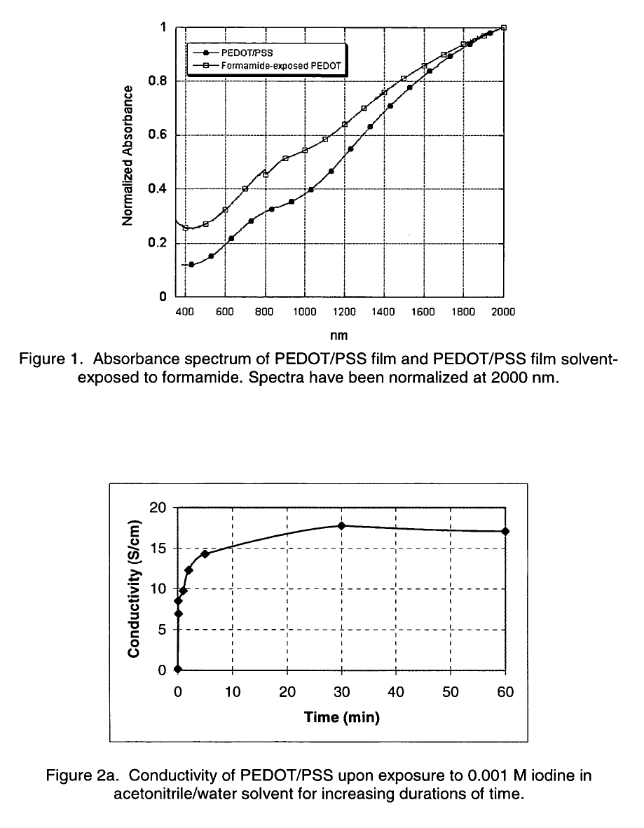

Secondary doping increases the conductivity of doped polyaniline by about two to five orders of magnitude. Secondary doping is conventional process for treating polymeric films. Secondary doping is achieved by casting the polyaniline from a “select” solvent. For example, polyaniline p-doped by camphor sulfonic acid cast from chloroform has a conductivity of 0.1 S/cm, while the same polymer cast from m-cresol solvent has a conductivity of up to 400 S/cm. A second way to achieve secondary doping is to cast from a standard solvent a doped polyaniline film, then expose the film to vapors of a “select” solvent for several hours. The vapors will be absorbed, and conductivity enhancement will be achieved. Secondary doping differs from the conductivity enhancement method described in this invention in two major ways. Secondary doping only applies to polymers cast from organic solution. It has not been demonstrated for waterborne conductive polymers. The second difference is that in secondary doping, there is a large change in the absorbance spectrum when the polymer is in the presence of the “select” solvent or following casting from the “select” solvent compared to the spectrum in the presence of or cast from a standard solvent. Polyaniline films cast from a standard solvent such as chloroform have a primary absorbance at 780 nm and a smaller one at 360 nm. Films cast from a “select” solvent such as m-cresol no longer have an absorbance peak at 780 nm, rather at 360 nm and a long tail into the infrared with a peak greater than 2600 nm. These changes are indicative of conductivity changes arising from changes in the conformation of the tertiary structure of the polymer. In a “select” solvent, the polymer has been shown to adopt an expanded coil structure, while in a standard solvent, the polymer collapses to a compact coil conformation. No significant spectroscopic change is noted following conductivity enhancement of a waterborne doped polythiophene by the conductivity enhancement method that is the subject of this invention: FIG. 1 shows that the absorbance spectrum is nearly the same for a film of PEDOT/PSS and a film of PEDOT/PSS that had been submersed in formamide solvent (for two one-minute exposures, rinsed with water, then dried), though the conductivity of the formamide-exposed film was 420 times higher than that of the original film. There is also little change in the absorbance spectrum of PEDOT/PSS following exposure to other solvents that provide conductivity increases. The inventive process is an improvement over the effectiveness of secondary doping methods.

There are different mechanisms for conductivity enhancement caused by addition of solvent/additives to an aqueous dispersion of doped conducting polymer such as PEDOT/PSS and the subject of this invention which is conductivity enhancement effected by exposure of solvent or solvent with additives to a cast film of doped conducting polymer. This was confirmed by examining the conductivity of PEDOT/PSS following solvent pre-addition to an aqueous dispersion, and comparing it with PEDOT/PSS conductivity following solvent post-exposure with the same solvents. As shown in Table 1, with certain solvents, the solvent pre-addition method can produce conductivity enhancements up to a factor of 9.9 times greater than the solvent post-exposure method, or the solvent post-exposure method can produce conductivity enhancements up to a factor of 79 times greater than that of the solvent pre-addition method.

TABLE 1
Conductivity effect on PEDOT/PSS

| | Solvent Pre- | Solvent Post- | Relative |
|---|---|---|---|
| | addition | Exposure | Conductivity Ratio |
| | Conductivity | Conductivity | (Post-exposure/ |
| Solvent/Additive | (S/cm)^{b} | (S/cm)^{a} | Pre-addition) |
| Formamide | 36 | 18 | ¹/_{2.1} |
| Ethylene carbonate^{e} | 19 | 13 | ¹/_{1.5} |
| Dimethylsulfoxide | 11 | 4.6 | ¹/_{2.5} |
| Dimethylacetamide | 4.8 | 2.0 | ¹/_{2.4} |
| N-Methylpyrrolidinone | 31 | 3.1 | ¹/_{9.9} |
| Acetic acid | 0.063 | 5.0 | 79 |
| Pyridine | 0.063 | 3.0 | 48 |
| 0.01 M I₂ in methanol | 0.17 | 8.9 | 52 |
| (Sorbitol) | 190^{d} | 240^{c} | 1.3 |
| 0.01 M I₂ in | | | |
| acetonitrile | | | |

^{a}Film exposed to solvent for 30 minutes.
^{b}5 wt % solvent added to PEDOT/PSS dispersion.
^{c}A film of Orgacon PEDOT/PSS containing 2.4 wt % sorbitol was used.
^{d}A solution of Orgacon PEDOT/PSS was mixed with sorbitol and I₂ in acetonitrile then cast into a film.
^{e}Ethylene carbonate was used as a 50 wt % solution in water.

The methods reported prior to this invention for enhancing the conductivity of waterborne polymers all pertain to combining solvents or additives within the waterborne dispersion, and then casting a film. However, not all solvents will be compatible with the aqueous dispersion or solution and may cause it to destabilize, greatly reducing the shelf life. Some solvents or additives can cause the formation of discontinuous or cracked films, reducing the surface coverage, film uniformity, and conductivity.

The following Examples are provided to illustrate certain aspects of the invention and shall not limit the scope of any claims appended hereto.

### EXAMPLES

Baytron P PEDOT/PSS dispersions used in these Examples were obtained from H. C. Starck (V4071) and Sigma-Aldrich. The concentration was 1.3 wt % polymer combined, with 0.5 wt % PEDOT and 0.8 wt % PSS. Orgacon PEDOT/PSS dispersions were obtained from Agfa. Conductivity enhancements were independent of the source or grade of PEDOT/PSS. PTT/PSS was synthesized using a similar procedure to that described by U.S. patent application Ser. No. 10/193,598 to Sotzing et al.; hereby incorporated by reference. Conductivity was measured by the four-point probe method Film thickness was measured by profilometry.

### Example 1

### Casting of PEDOT/PSS Doped Conducting Polymer Films from Aqueous Dispersion

Clean glass microscope slides were cut into 1″×1″ pieces and the surface was wiped and blown free of particles. The substrate was placed on the vacuum chuck of a spin coater, and 1 mL of PEDOT/PSS dispersion was pooled covering the entire surface. The spinner was spun at 400 rpm for 20 seconds, 600 rpm for 20 seconds, 1200 rpm for 20 seconds, then 3000 rpm for 1 minute to cast a film approximately 200 nm thick. The glass slide and film were placed on a thermochuck in a nitrogen purged chamber and heated to 200 C for five minutes. The film thickness was measured by profilometry (typically 161-199 nm) and the conductivity was measured by the four-point probe method (typically 0.18-0.24 S/cm).

### Example 2

### Solvent Post-Exposure to Cast Films of PEDOT/PSS

Conducting PEDOT/PSS polymer films were cast on glass slides and heated as in Example 1. The film thickness and conductivity were measured. The slide was carefully placed in a beaker containing 20-50 mL of solvent so that the solvent completely covered the polymer film. After a specified amount of time (30 minutes -1 hour), the slide was removed and placed in a beaker containing 200 mL of deionized water in order to remove the solvent. After two minutes, the slide was removed from the beaker of water, placed on a spinner and spun at 3000 rpm for 1 minute to dry the film. Heating to 90° C. for 2 minutes under nitrogen dried the film further. The film thickness and conductivity were measured and compared to the initial values. The “conductivity increase factor” is the ratio of the final to initial conductivity; if the conductivity decreased, it is the negative of the ratio of initial to final conductivity. Results are shown in Table 2. The film thickness typically decreased by less than 10%, and may have decreased as much as 20%. There is a general correlation of higher film conductivity with higher dielectric constant of the solvent used to treat the polmeric film. There is also a correlation of conductivity enhancement with water solubility of the solvent. With the exception of triethylamine and triethanolamine, all of the solvents which produced conductivity enhancements are soluble in water to greater that 1 wt %

TABLE 2
Conductivity effect on PEDOT/PSS

| | | | | Thickness | | Solvent |
|---|---|---|---|---|---|---|
| | PEDOT/PSS | Conductivity | Initial Film | After | Solvent | Water |
| | Conductivity | Increase | Thickness | Exposure | Dielectric | Solubility |
| Solvent | (S/cm) | Factor | (nm) | (nm) | Constant | (wt %) |
| (none) | 0.18-0.24 | — | 161-199 | — | — | — |
| Acetic acid | 5.0 | 23 | 187.3 | 173.5 | 6.I5 | 100% |
| Acetonitrile | 1.0 | 4.6 | 198.8 | 192.3 | 37.5 | 100% |
| Dimethylacetamide | 2.0 | 8.5 | 187.2 | 173.5 | 59 | 100% |
| DMSO | 4.6 | 20 | 195.6 | 188.1 | 46.7 | 100% |
| Ethylene | 12.0 | 53 | 167.2 | 171.3 | 89.8 | 100% |
| carbonate^{a} | | | | | | |
| Ethylene Glycol | 20 | 85 | 170.7 | 148.2 | 37.7 | 100% |
| Formamide | 18 | 78 | 176.6 | 157.4 | 111 | 100% |
| Methanol | 0.65 | 3.0 | 199.3 | 184.5 | 32.7 | 100% |
| Nitromethane | 0.14 | −1.3 | 188.4 | 167.9 | 35.9 | 0.1% |
| NMP | 3.1 | 13 | 178.2 | 162.1 | 32 | 100% |
| Pyridine | 3.0 | 20 | 168.7 | 146.5 | 13.3 | 100% |
| 2,2,3,3- | 9.9 | 58 | 181.1 | 149.2 | 21.0 | — |
| Tetrafluoro-1- | | | | | | |
| propanol | | | | | | |
| THF | 0.75 | 3.5 | 161.2 | 143.8 | 7.57 | 100% |
| Water | 0.20 | −1.6 | 136.3 | 130.9 | 80.1 | 100% |
| EDOT | 0.0059 | −12 | 199.4 | 208.5 | — | 0.13% |
| m-Cresol | 0.12 | 1.0 | 193.9 | 199.7 | 12.4 | 2.2% |
| Dimethylcarbonate | 0.12 | −1.1 | 159.7 | 141.5 | 3.1 | — |
| Triethylamine | 0.0048 | −34 | 175.6 | 168.9 | 2.4 | 7.4% |
| Triethanolamine | 0.0064 | −26 | 167.7 | 201.4 | 29.4 | 100% |
| Sorbitol^{b} | 0.13 | −1.2 | 161.6 | 136.1 | 35.5 | 100% |
| Sorbitol^{b,c} | 0.26 | −2.5 | 161.6 | 135.7 | 35.5 | 100% |

^{a}Ethylene carbonate was used as a 50 wt % solution in water. Sorbitol was used as a 20 wt % solution in water.
^{c}The film was additionally heated to 200° C. for 2 minutes after solvent post-exposure.

### Example 3

### Conductivity Enhancement from Multiple Solvent Post-Exposures

Conducting polymer films were cast on glass slides and heated as in Example 1. The film thickness and conductivity were measured. Single exposures to solvent were carried out as in Example 2. Double exposure was conducted as follows: the slide was carefully placed in a beaker containing 20-50 mL of solvent so that the solvent completely covered the polymer film. After a specified amount of time (1 minute), the slide was removed and placed in a beaker containing 200 mL of deionized water in order to remove the solvent. After two minutes, the slide was removed from the beaker of water, placed on a spinner and spun at 3000 rpm for 1 minute to dry the film. A second exposure was immediately conducted by placing the slide carefully in a beaker containing 20-50 mL of solvent for a specified amount of time (1 minute), then removing the slide and placing it in a beaker containing 200 mL of deionized water in order to remove the solvent. After two minutes, the slide was removed from the beaker of water, placed on a spinner and spun at 3000 rpm for 1 minute to dry the film. Heating to 90° C. for 2 minutes under nitrogen dried the film further. The film thickness and conductivity were measured and compared to the initial values.

TABLE 3
Conductivity effect on PEDOT/PSS

| | | | Double exposure | |
|---|---|---|---|---|
| | | | (2 × 1 min) | |
| | Single exposure (30 min) | | | Conductivity |
| | Conductivity | Conductivity | Conductivity | Increase |
| Solvent | (S/cm) | Increase Factor | (S/cm) | Factor |
| NMP | 3.1 | 13 | 0.81 | 14 |
| DMAc | 2.0 | 8.5 | 0.40 | 6.6 |
| Formamide | 18 | 78 | 28 | 420 |

Each experiment was performed using a different control and, therefore, the initial conductivity was different.

### Example 4

### Solvent Post-Exposure to Cast Films of PTT/PSS

PTT/PSS was prepared according to the procedure disclosed in U.S. patent application Ser. No.10/755,426, filed Jan. 12, 2004; hereby incorporated by reference. PTT/PSS conducting polymer films were cast on glass slides and heated as in Example 1. The film thickness and conductivity were measured. The films were exposed to solvents using the double exposure technique in Example 3. Conductivity increases were obtained in all cases except with solvents that are soluble in water to less than 0.1 wt %.

TABLE 4
Conductivity effect on PTT/PSS

| | | Conductivity | | | Solvent |
|---|---|---|---|---|---|
| | Initial | After | Conductivity | Solvent | Water |
| | Conductivity | Exposure | increase | Dielectric | Solubility |
| Exposure conditions | (S/cm) | (S/cm) | factor | Constant | (wt %) |
| Dimethylacetamide | 0.0069 | 0.063 | 9.2 | 59 | 100% |
| Acetic acid | 0.010 | 0.078 | 7.4 | 6.I5 | 100% |
| Formamide | 0.0067 | 0.046 | 6.9 | 111 | 100% |
| Dimethylsulfoxide | 0.0098 | 0.066 | 6.7 | 46.7 | 100% |
| Ethylene carbonate^{a} | 0.013 | 0.089 | 6.6 | 89.8 | 100% |
| Ethylene glycol | 0.0088 | 0.051 | 5.8 | 37.7 | 100% |
| Isopropanol | 0.012 | 0.065 | 5.3 | 20.2 | 100% |
| Acetonitrile | 0.0094 | 0.048 | 5.1 | 37.5 | 100% |
| Nitromethane | 0.012 | 0.057 | 4.8 | 35.9 | 0.1% |
| NMP | 0.0069 | 0.018 | 2.5 | 32 | 100% |
| THF | 0.012 | 0.012 | 1.0 | 7.57 | 100% |
| Hexane | 0.012 | 0.0051 | −2.4 | 1.89 | 0.001% |
| Toluene | 0.011 | 0.0040 | −2.8 | 2.39 | 0.052% |

^{a}Ethylene carbonate was used as a 50 wt % solution in water.

A comparison of Example 1 and Example 2 illustrates that the conductivity of PTT/PSS is much less effected than PEDOT/PSS by analogous solvent treatments; the maximum conductivity change is less than a factor of 10. The invariability of PTT/PSS to solvent treatment is desirable given the solvent processing required for using a conducting polymer as a hole injection layer in light emitting diodes, and other organic electronics. Conductive polymers have been found also to be able to improve the performance of organic material based devices. For example, in organic or polymer based light emitting diodes (OLEDs or PLEDs), conductive polymers with desired conductivities (10⁻⁶ to 10⁻¹ S/cm) can be used as the hole injection layer to greatly improve the device efficiency and stability (lifetime), while lowering the device operating voltage. For high resolution and low cost fabrication of such devices, printing methods such as ink jet printing, gravure printing, screening printing can be used. To formulate the conductive polymer inks for such printing methods, solvents with polarity or high boiling point are frequently added into the conductive polymer dispersions to adjust/control the drying process, so as to form uniform film of the conductive polymer after drying. Ideally, the conductivity of the conductive polymers should not change after the ink formulation. However, the conductivity of PEDOT based conductive polymers changes dramatically after the addition of polar solvents, which makes it difficult or impossible to formulate PEDOT based conductive polymers for PLEDs or OLEDs hole injection layer applications. For example, the much increased conductivity will cause a conductive polymer that is designed for passive matrix displays to cause crosstalk issue. However, the conductivity of PTT based conductive polymers is almost independent of the solvent that is used to formulate the ink. This feature greatly facilitates usage of such ink formulations by allowing for a wide range of solvents to be chosen for the desired drying process and film uniformity. Therefore, PTT based conductive polymers are ideally suited for printing methods.

### Example 5

### Effect of Thermal Treatment on Conductivity Enhancement

Conducting polymer films were cast on glass slides and heated as in Example 1. The film thickness and conductivity were measured. Single exposures to solvent were carried out as in Example 2. Conductivity data is shown in the Table. To examine the effect on conductivity of complete solvent removal, the films were heated to 200° C. for 30 minutes, and then the conductivity was measured again. The conductivity of the nitromethane-treated sample increased slightly. In most cases, the conductivity decreased by 10% to 28%, or as high as 49% or 77%. Without wishing to be bound by any theory or explanation, it is believed that the conductivity decrease could be due to more than just solvent removal. It is also believed that the high temperature could cause decomposition of the polymer (aryl sulfonic acids are known to desulfonate at this temperature) or reactivity with solvent that would degrade conductivity. However, the overall conductivity increase was still as high as a factor of 70.5. The fact that conductivity increases were achieved even after fully vaporizing the solvent indicates that the solvent is not required to maintain the increased conductivity.

TABLE 5
Conductivity effect on PEDOT/PSS from solvent exposure and thermal treatment

| | | | Conductivity | Overall |
|---|---|---|---|---|
| | Conductivity | Conductivity After | Change Upon | Conductivity |
| | After Solvent | Thermal | Thermal | Increase |
| Exposure Solvent | Exposure | Treatment^{a} | Treatment | Factor |
| Ethylene glycol | 20 | 15 | −23% | 65 |
| Formamide | 18 | 16 | −9.9% | 71 |
| Ethylene carbonate^{b} | 12 | 2.8 | −77% | 12 |
| Acetic acid | 5.0 | 4.3 | −14% | 20 |
| DMSO | 4.6 | 2.4 | −49% | 12 |
| NMP | 3.1 | 2.2 | −28% | 9.6 |
| Dimethyl acetamide | 2.0 | 1.5 | −220% | 6.7 |
| Acetonitrile | 1.0 | 0.88 | −16% | 4.6 |
| THF | 0.75 | 0.57 | −24 | 2.7 |
| Methanol | 0.65 | 0.52 | −19% | 2.4 |
| Nitromethane | 0.14 | 0.15 | 9.1% | −1.2 |

^{a}Sample heated to 200° C. for 30 minutes under nitrogen.
^{b}Ethylene carbonate was used as a 50 wt % solution in water.

### Example 7

### Effect of Solvent Removal by Vacuum Treatment

A conducting polymer film was cast on a glass slides and heated as in Example 1. The film thickness and conductivity were measured. A single exposure to solvent was carried out as in Example 2. To examine the effect of complete removal of solvent on conductivity, the film was placed under a dynamic vacuum of 10⁻² Torr at room temperature for 24 hours, and then the conductivity was measured again. The conductivity decreased by only 4.2%, leaving an overall increase of a factor of 243.8.

TABLE 7
Conductivity effect on PEDOT/PSS after solvent exposure and removal

| | Conductivity | | | |
|---|---|---|---|---|
| | After | Conductivity | | Conductivity |
| Exposure | Solvent | After Vacuum | Conductivity | Increase |
| Solvent | Exposure | Treatment^{a} | Change | Factor |
| Formamide | 60 | 54 | −4.2% | 244 |

^{a}Solvent removed by exposure to dynamic vacuum of 10⁻² Torr at room temperature for 24 hours.

### Example 8

### Effect of Solvent Post-Exposure Followed by Evaporation

A PEDOT/PSS film was cast on glass slides and heated as in Example 1. The film thickness and conductivity were measured. Single exposure to acetonitrile solvent was carried out as in Example 2. The resulting conductivity was 1.05 S/cm as recorded in Table 8, and the film thickness decreased by 6.5 nm. Without wishing to be bound by any theory or explanation it is believed that the reason for the conductivity enhancement could be due to the solvent rinsing impurities out of the conducting polymer film. To test this, 1 mL of acetonitrile solvent was pooled onto another film of PEDOT/PSS prepared as in Example 2. The solvent was allowed to evaporate over 16 hours at ambient conditions leaving a completely dry film. The film thickness had only decreased by 1.0 nm. The conductivity increased to 4.77 S/cm, 4.5 times larger than that resulting from the dip exposure conditions. It is also believed that his demonstrates that removal of impurities from PEDOT/PSS is not responsible for the conductivity increase.

TABLE 8
Conductivity effect on PEDOT/PSS

| | | | | | Ratio of |
|---|---|---|---|---|---|
| | | | | | Exposure/ |
| | Thickness | Thickness | Solvent | | Evaporation |
| | before | After | Exposure/ | | to Dip |
| | Exposure/ | Exposure/ | Evaporation | Dip Exposure | Exposure |
| Solvent | Evaporation | Evaporation | Conductivity | Conductivity | Conductivity |
| acetonitrile | 138.0 | 137.0 | 4.8 | 1.1 | 4.5 |

### Example 9

### Conductivity Enhancement Effect of Multiple Solvent Post-Exposures and Water Rinse

PEDOT/PSS films were cast on glass slides and heated as in Example 1. The film thicknesses and conductivities were measured. A film was carefully placed in a beaker containing 20-50 mL of formamide so that the solvent completely covered the polymer film. The film was left submerged for 20 seconds, then removed and held in the air for 10 seconds. This dip exposure then removal was repeated five more times over three minutes. The slide was then carefully placed in a beaker of 200 mL deionized water to rinse out the solvent. After two minutes, the slide was removed from the beaker of water, placed on a spinner and spun at 3000 rpm for 1 minute to dry the film. Heating to 90° C. for 2 minutes under nitrogen dried the film further. A higher conductivity of 28.44 S/cm is achieved by this method than the single exposure or double exposure methods. A second film of PEDOT/PSS was repeatedly exposed to formamide over three minutes as above. This film was not rinsed with water. It was spun dry at 3000 rpm then baked at 90° C. under nitrogen for two minutes. The conductivity and conductivity increase factor are more than twice that of the sample rinsed with water. Baking the film at 200° C. for three hours under nitrogen to remove solvent only decreased the conductivity by 8.3%, leaving an overall conductivity increase of over a factor of 233. Conductivities of the two films are shown in Table 9.

TABLE 9
Conductivity effect on PEDOT/PSS from multiple solvent exposures

| | Solvent Post-exposure | Conductivity | Conductivity |
|---|---|---|---|
| Solvent | Conditions | (S/cm) | Increase Factor |
| Formamide | multiple exposures (3 min) | 28 | 120 |
| | water rinse | | |
| | 90° C. bake | | |
| Formamide | multiple dips (3 min) | 60 | 250 |
| | no water rinse | | |
| | 90° C. bake | | |
| | bake 200° C., 3 hour | 55 | 230 |

### Example 10

### Effect of Solvent Exposure Duration

Conducting polymer films were cast on glass slides and heated as in Example 1. Film thicknesses and conductivities were measured. Solvent exposures to methanol were carried out as in Example 2 for 0.5 hours for one sample and 65 hours for the second sample. The conductivity increase factor and film thickness changes were nearly the same for both samples indicating that conductivity enhancement can reach saturation within 30 minutes for this solvent.

TABLE 10
Conductivity effect on PEDOT/PSS

| | | | | Thickness |
|---|---|---|---|---|
| | | | Initial | After |
| | Exposure | Conductivity | Thickness | Exposure |
| Solvent | Time | Increase Factor | (nm) | (nm) |
| Methanol | 0.5 hour | 3.0 | 199.3 | 184.5 |
| Methanol | 65 hour | 3.8 | 201.8 | 189.2 |

Without wishing to be bound by any theory or explanation it is believed that the conductivity enhancement of PEDOT/PSS films upon solvent exposure can be explained by the following model. PEDOT/PSS can be represented by core-shell emulsion particles in water solution where an ionic, hydrophilic PSS shell surrounds a PEDOT core. This core-shell morphology can be maintained in the cast film. The non-conductive PSS can reduce the contact between the conductive PEDOT regions. It is believed that this reduces percolation of the conductive regions and limits the bulk conductivity. When the film is exposed to a solvent under standard dip-exposure conditions, the particles may swell. In an effective solvent (water soluble, high dielectric constant), the polymers move toward a more homogeneous blend. PEDOT can be drawn out and forms more intimate contact with neighboring polymer chains. This uniform blend can be maintained even after solvent removal. With a greater number of conduction pathways, and decreased distance between chains for electron hopping, the conductivity increases.

### Example 11

### Conductivity Enhancement by Exposure of Polymer Films to Oxidant and Solvent

NO₂BF₄ and NO₂SbF₆ were tested for their abilities to dope the PEDOT/PSS polymer and enhance its conductivity. A PEDOT/PSS film prepared according to Example 1 was placed in a sealed chamber (˜1 L in volume) in a nitrogen glove box along with 0.2 g of NO₂BF₄ and left at ambient conditions for 3 hour. The film became rough. The film was removed from the chamber and placed in the hood for 1 hour for excess NO₂BF₄ to sublime. The roughness did not diminish. The conductivity of the film was 8.2 S/cm, an increase by a factor of 60.5.

A PEDOT/PSS film was exposed to NO₂BF₄ vapors in a sealed chamber in a nitrogen atmosphere for 3.5 days. The film became rough, white, opaque, and non-conductive. A solution of NO₂BF₄ (0.1 M in dry acetonitrile) was prepared and used to treat a PEDOT/PSS film for 1 hour. All exposures of NO₂BF₄ solutions to PEDOT/PSS were conducted in a nitrogen filled glove box. After exposing the film to the solution for 1 hour, it was rinsed in acetonitrile for two minutes then spin dried at 3000 rpm. The film was smooth but had changed in color from blue to purple. The film's conductivity was less than 10⁻⁶ S/cm. PEDOT/PSS was exposed to a 0.1 M solution of NO₂SbF₆ in acetonitrile for 1 min in a nitrogen glove box, then rinsed in acetonitrile, then dried. The conductivity decreased by a factor of 2. A more dilute 0.001 M solution of NO₂BF₄ in acetonitrile was prepared and used to expose a PEDOT/PSS film for 1 min. A conductivity increase by a factor of 28.2 resulted. A 1 hour exposure to the 0.001 M solution resulted in a factor of 52.0 increase to 6.5 S/cm. The conductivity increase is much greater than that of acetonitrile alone indicating that oxidants such as NO₂BF₄ can effectively increase the conductivity of conducting polymer films.

To compare solvent/additive post-exposure with solvent/additive pre-addition, 5 wt % of 0.1 M NO₂BF₄ in acetonitrile was added to a PEDOT/PSS solution. After 2 hour, a film was cast, and the conductivity measured. The conductivity was 0.15 S/cm, approximately that observed for an unaltered PEDOT/PSS film. Addition of 5 wt % of 0.001 M NO₂BF₄ in acetonitrile to a PEDOT/PSS solution for two hours gave a very similar conductivity, 0.14 S/cm.

TABLE 11
Conductivity effect on PEDOT/PSS from exposure to oxidants

| | | | | | Conduc- |
|---|---|---|---|---|---|
| | | | | Conduc- | tivity |
| | | | | tivity | Increase |
| Oxidant | Duration | | Solvent | (S/cm) | Factor |
| NO₂BF₄ | 3 | hr | (vapors) | 8.16 | 60.5 |
| NO₂BF₄ | 24 | hr | (vapors) | <10⁻⁶ | — |
| 0.1 M NO₂BF₄ | 1 | hr | acetonitrile | <10⁻⁶ | — |
| 0.1 M NO₂SbF₆ | 1 | min | acetonitrile | 0.053 | −2.0 |
| 0.001 M NO₂BF₄ | 1 | min | acetonitrile | 3.0 | 28 |
| 0.001 M NO₂BF₄ | 1 | hr | acetonitrile | 6.5 | 52 |
| 5 wt % 0.1 M NO₂BF₄ | 2 | hr | acetonitrile | 0.15 | ˜1 |
| added to PEDOT | | | | | |
| dispersion | | | | | |
| 5 wt % 0.001 M | 2 | hr | acetonitrile | 0.14 | ˜1 |
| NO₂BF₄ added to | | | | | |
| PEDOT dispersion | | | | | |

### Example 12

### Conductivity Enhancement by Exposure of Polymer Films to Oxidant and Solvent

Conducting polymer films were cast on glass slides and heated as in Example 1. The film thicknesses and conductivities were measured. Single exposures to the oxidant solutions listed in Table 12 were carried out as in Example 2 for the duration of time shown in the table. Various oxidants were tested in the vapor phase, in aqueous solution, in aqueous/organic solution, and in organic solution. Ten second exposures of NaOCl aqueous solution or KMnO₄ aqueous solution removed the film from the glass slide. Exposures of aqueous solutions of (NH₄)₂S₂O₈ or Fe₂(SO₄)₃ to PEDOT/PSS resulted in conductivity decreases. Exposure of PEDOT/PSS to an iron(III) complex, Fe(tosylate)₃, in all organic solvent, methanol/acetonitrile, resulted in a conductivity increase of over a factor of 118. A PEDOT/PSS film was sealed in a 400 mL volume chamber with 0.2 g iodine at ambient conditions for 24 hours. This exposure produced no change in the conductivity of the polymer. Exposures of PEDOT/PSS to dilute solutions of iodine in acetonitrile, water/acetonitrile, methanol/acetonitrile, methanol, ethylene glycol, or formamide resulted in conductivity increases of a factor of 62 to 164. Formamide was the most effective solvent with iodine for creating a conductivity increase. The concentration of iodine was not observed as being a critical parameter in this Example: 0.1 M iodine in methanol produced a factor of 74.5 increase in conductivity, and 0.01 M iodine in methanol produced a factor of 70.3 conductivity increase. Iodine in acetonitrile/water at 0.001 M concentration produce a factor of 126.1 increase in conductivity, while 0.01 M iodine in the same solvent increased the 5 conductivity by a factor of 92.3. These data show that exposure of conductive polymers to oxidants such as iron(III) tosylate or iodine in conjunction with organic solvent can produce conductivity enhancements greater than that produced by solvent alone.

TABLE 12
Conductivity effect on PEDOT/PSS from exposure to oxidants and solvents.

| | | | | | Conductivity |
|---|---|---|---|---|---|
| Oxidant | Duration | | Solvent | Conductivity (S/cm) | Increase Factor |
| 1 wt % NaOCl | 10 | sec | water | film removed | — |
| 1.6 wt % KMnO₄ | 10 | sec | water | film removed | — |
| 0.01 M | 1 | min | water | 0.084 | −1.6 |
| (NH₄)₂S₂O₈ | | | | | |
| 0.01 M | 1 | min | water | 0.050 | −2.9 |
| Fe₂(SO₄)₃ | | | | | |
| 0.1 M Fe₂(SO₄)₃ | 1 | min | water | 0.074 | −1.8 |
| 0.05 M | 1 | min | MeOH/acetonitrile | 8.0 | 118.4 |
| Fe(tosylate)₃ | | | | | |
| Iodine | 24 | hr | (vapors) | 0.15 | 1 |
| 0.01 M Iodine | 1 | hr | acetonitrile | 14 | 62 |
| 0.01 M Iodine | 1 | hr | water/acetonitrile | 18 | 92 |
| 0.001 M Iodine | 30 | min | water/acetonitrile | 18 | 130 |
| 0.05 M Iodine | 1 | min | MeOH/acetonitrile | 4.5 | 66 |
| 0.01 M Iodine | 1 | hr | MeOH | 8.9 | 70 |
| 0.1 M Iodine | 1 | hr | MeOH | 6.6 | 74 |
| 0.01 M Iodine | 30 | min | ethylene glycol | 17 | 100 |
| 0.01 M Iodine | 30 | min | formamide | 29 | 160 |

### Example 13

### Effect of Duration of Solvent Exposure

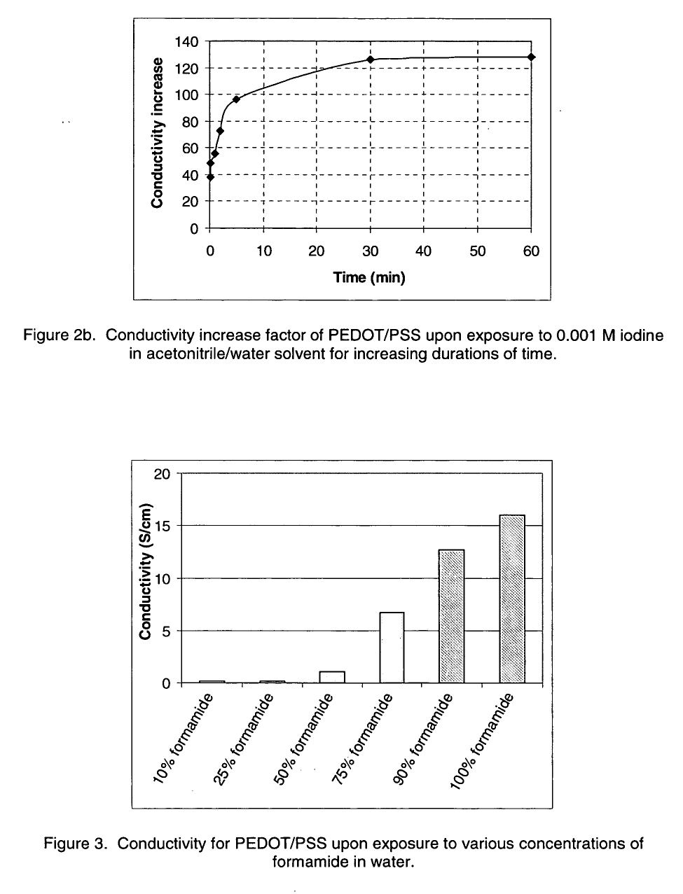

Conducting polymer films were cast on glass slides and heated as in Example 1. The film thicknesses and conductivities were measured. Single exposures to 0.001 M iodine in acetonitrile/water solutions for the durations shown in Table 13 were carried out as in Example 2. The conductivity and conductivity increase factor increased rapidly at relatively short exposure times. Extended exposure of 17 hours resulted in a slight conductivity decrease from its maximum value (e.g., refer to FIGS. 2a and 2b).

TABLE 13
Conductivity effect on PEDOT/PSS

| Exposure | | Conductivity | Conductivity |
|---|---|---|---|
| time | | (S/cm) | increase factor |
| 10 | sec | 6.9 | 38 |
| 30 | sec | 8.5 | 48 |
| 1 | min | 9.7 | 55 |
| 2 | min | 12 | 73 |
| 5 | min | 14 | 96 |
| 30 | min | 18 | 130 |
| 1 | hr | 17 | 128 |
| 17 | hr | 15 | 104 |

### Example 14

### Effect of Thermal Treatment on Conductivity Enhancement

Conducting polymer films were cast on glass slides and heated as in Example 1. The film thicknesses and conductivities were measured. A single exposure to 0.01 M iodine in acetonitrile/water solution for 1 hour was carried out as in Example 2. The thickness and was measured, and the conductivity had increased to 17.59 S/cm. The sample was heated to 200° C. for 30 minutes under nitrogen, and then the conductivity was measured again. The conductivity had decreased to 11.67 S/cm, which is an overall conductivity increase by a factor of 51.7.

TABLE 14
Conductivity effect on PEDOT/PSS

| | | | | Overall |
|---|---|---|---|---|
| Exposure | Conductivity | Conductivity | | Conductivity |
| Solvent/ | After Solvent | After Thermal | Conductivity | Increase |
| Additives | Exposure | Treatment^{a} | Change | Factor |
| 0.01 M I₂/ | 18 | 12 | −34% | 52 |
| NCCH₃/ | | | | |
| water | | | | |

^{a}Sample heated to 200° C. for 30 minutes under nitrogen.

### Example 15

### Effect of Solvent/Additive Removal by Vacuum Treatment

Conducting polymer films were cast on glass slides and heated as in Example 1. The film thicknesses and conductivities were measured. A single exposure to 0.001 M iodine in acetonitrile/water solution for 1 hour was carried out as in Example 2. The thickness and conductivity were measured, and the conductivity had increased to 17.78 S/cm. The sample was placed under dynamic vacuum of 10⁻² Torr at room temperature for 65 hours, and then the conductivity was measured again. The conductivity decreased slightly by 1.1% leaving an overall conductivity enhancement of a factor of 116.7.

TABLE 15
Conductivity effect on PEDOT/PSS

| | Conductivity | | | |
|---|---|---|---|---|
| Exposure | After | Conductivity | | Conductivity |
| Solvent/ | Solvent | After Vacuum | Conductivity | Increase |
| Additives | Exposure | Treatment^{a} | Change | Factor |
| 0.001 M I₂/ | 18 | 16 | −1.1% | 120 |
| NCCH₃/ | | | | |
| water | | | | |

^{a}Solvent removed by exposure to dynamic vacuum of 10⁻² Torr at room temperature for 65 hours.

### Example 16

### Conductivity Enhancement by Alternating Exposure to Solvents

Conducting polymer films were cast on glass slides and heated as in Example 1. The film thicknesses and conductivities were measured. A slide was carefully placed in a beaker containing 20-50 mL of formamide so that the solvent completely covered the polymer film. After a 1 minute, the slide was removed and placed in a beaker containing 200 mL of deionized water for 1 minute to rinse out the solvent. The film was then spun dry on a spin coater at 3000 rpm for 1 minute. A second exposure was made by submersing the film in formamide for 1 minute, then rinsing in water for 1 minute, followed by spin drying for 1 minute. A third exposure was made by submersing the film in formamide for 1 minute, then rinsing in water for 1 minute, followed by spin drying for 1 minute. This procedure was repeated on a second film of PEDOT/PSS except with exposure to formamide/THF/formamide. The procedure was repeated on a third film of PEDOT/PSS except with 4 solvent exposures: to formamide/nitromethane/ formamide/nitromethane. Heating the slides to 90° C. for 2 minutes under nitrogen dried the films further. The film thicknesses and conductivities were measured and compared to the initial values. For the three examples, the conductivity increased by a factor of 140 to 168.

TABLE 16
Conductivity effect on PEDOT/PSS

| | | Initial | Conductivity | Conductivity |
|---|---|---|---|---|
| | Exposure | Conductivity | After Exposure | Increase |
| Solvent | Time | (S/cm) | (S/cm) | Factor |
| formamide | 1 min | 0.13 | 20 | 150 |
| formamide | | | | |
| formamide | | | | |
| formamide | 1 min | 0.13 | 18 | 140 |
| THF | | | | |
| formamide | | | | |
| formamide | 1 min | 0.13 | 20 | 170 |
| nitromethane | | | | |
| formamide | | | | |
| nitromethane | | | | |

### Example 17

### Effect of Solvent Concentration on Conductivity Increase

Conducting polymer films were cast on glass slides and heated as in Example 1. The film thicknesses and conductivities were measured. A single exposure to formamide for 1 minute in water at the concentrations shown in Table 17 was carried out as in Example 2. The film thicknesses and conductivities were measured and compared to the initial values. The conductivity change is graphically shown in FIG. 3. There is no conductivity increase upon exposure to 10% formamide in water. The conductivity increases as the concentration of formamide is increased, yielding the largest conductivity enhancement in 100% formamide.

TABLE 17
Conductivity effect on PEDOT/PSS

| | Ex- | | Conductivity | |
|---|---|---|---|---|
| | po- | Initial | After Solvent | Conductivity |
| Exposure | sure | Conductivity | Post-exposure | Increase |
| concentrations | time | (S/cm) | (S/cm) | Factor |
| 10% formamide | 1 min | 0.1593 | 0.13 | 0.84 |
| 25% formamide | 1 min | 0.1588 | 0.19 | 1.2 |
| 50% formamide | 1 min | 0.1445 | 1.1 | 7.6 |
| 75% formamide | 1 min | 0.1653 | 6.7 | 41 |
| 90% formamide | 1 min | 0.1579 | 13 | 80 |
| 100% formamide | 1 min | 0.1575 | 16 | 100 |

### Example 18

### Conductivity Enhancement from Exposure to Solvent, Oxidant, and Monomer

Examples in this disclosure have shown that exposure of conducting polymer films to organic solvents with additives such as oxidants produce relatively large conductivity enhancements. This example shows the effect on conductivity of exposing a polymer film to solvent, oxidant, and an additional organic additive, for example, a polymerizable monomer capable of forming a conjugated polymer, such as 3,4-ethylenedioxythiophene (EDOT). A solution was formed by combining equal volumes of 0.1 M EDOT in acetonitrile and 0.1 M Fe₂(SO₄)₃ in water as oxidant. The solution was used within 30 minutes of combining reagents. A 1 mL aliquot of this solution was pooled onto a PEDOT/PSS slide, prepared as in Example 1, that was resting on a spin coater chuck. After waiting 1 minute, the film was spun at 1500 rpm for 1 minute to remove the excess solution and dry the film. The film was left with an amber color. The film was baked at 100° C. for 2 minutes in air or nitrogen. The film had a blue-green tint. The thickness and conductivity of the film were measured. The procedure was repeated on a fresh film of PEDOT/PSS using a 0.1 M solution of Fe(tosylate)₃ in methanol as the oxidant. The procedure was repeated on a fresh film of PEDOT/PSS using a 0.1 M solution of iodine in methanol as the oxidant. The EDOT/ Fe₂(SO₄)3/water/acetonitrile combination produced a factor of 43.2 conductivity increase, while exposure to 0.1 M Fe₂(SO₄)₃ in water decreased the conductivity. The EDOT/Fe(tosylate)₃/methanol/acetonitrile combination produced a factor of 142.9 conductivity increase, while exposure to Fe(tosylate)3/methanol/acetonitrile produced a smaller increase of a factor of 118.4. The EDOT/iodine/methanol/acetonitrile combination produced a factor of 367.9 conductivity increase in PEDOT/PSS, while exposure to iodine/methanol/acetonitrile produced a smaller increase of a factor of 66.4. These data demonstrate that addition of a polymerizable monomer that can produce conjugated polymer to the exposure solution containing organic solvent and oxidant can greatly improve the conductivity enhancement over that of exposure to solvent alone or solvent and oxidant.

TABLE 18
Conductivity effect on PEDOT/PSS from exposure to
EDOT monomer, oxidant, and solvent

| | | | Con- | Conductivity |
|---|---|---|---|---|
| | | | ductivity | Increase |
| Monomer | Oxidant | Solvent | (S/cm) | Factor |
| EDOT | Fe₂(SO₄)₃ | water/acetonitrile | 4.0 | 43 |
| EDOT | Fe(tosylate)₃ | MeOH/acetonitrile | 10 | 140 |
| EDOT | Iodine | MeOH/acetonitrile | 35 | 370 |

### Example 19

### Conductivity Enhancement from Exposure to Solvent, Oxidant, and Monomer

This example shows the effect on conductivity of exposing a polymer film to solvent, oxidant, and an additional organic additive, for example, a polymerizable monomer capable of forming a conjugated polymer, such as EDOT. Solutions were formed by combining appropriate volumes of 0.1 M EDOT in acetonitrile and 0.1 M Fe(tosylate)₃ in methanol as oxidant to give 1:1, 1:2, or 2:1 molar solutions of EDOT:Fe(tosylate)₃. The solution was used within 30 minutes of combining reagents. A 1 mL aliquot of a solution was pooled onto a PEDOT/PSS slide, prepared as in Example 1, that was resting on a spin coater chuck. After waiting 1 minute, the film was spun at 1500 rpm for 1 minute to remove the excess solution and dry the film. The film was left with an amber color. The film was baked at 100° C. for 2 minutes in air or nitrogen. The film had a blue-green tint. The thickness and conductivity of the film were measured. This series of experiments was repeated using 0.1 M EDOT in acetonitrile and 0.1 M iodine in methanol as oxidant in 1:1, 1:2, or 2:1 molar ratios. It was found that a 1:2 molar ratio of EDOT:oxidant produces the largest conductivity increase: a factor of 151.8 for Fe(tosylate)₃, and a factor of 561.3 for iodine.

TABLE 19
Conductivity effect on PEDOT/PSS from exposure to EDOT monomer, oxidant,
and solvent

| | | | | Conductivity | |
|---|---|---|---|---|---|
| | | | Initial | After | Conductivity |
| | | Monomer:Oxidant | Conductivity | Treatment | Increase |
| Monomer | Oxidant | (molar ratio) | (S/cm) | (S/cm) | Factor |
| EDOT | Fe(tosylate)₃ | 2:1 | | 5.7 | 130 |
| EDOT | Fe(tosylate)₃ | 1:1 | | 10 | 140 |
| EDOT | Fe(tosylate)₃ | 1:2 | | 16.5 | 150 |
| EDOT | Iodine | 2:1 | | 30 | 430 |
| EDOT | Iodine | 1:1 | | 35 | 370 |
| EDOT | Iodine | 1:2 | | 34 | 560 |

### Example 20

### Conductivity Enhancement from Exposure to Solvent, Oxidant, and Monomer

This example shows the effect on conductivity of exposing a polymer film to solvent, oxidant, and an additional organic additive, for example, a polymerizable monomer capable of forming a conjugated polymer, such as EDOT or thieno[3,4-b]thiopehene (TT). Exposures were conducted on PEDOT/PSS and PTT/PSS polymer films. A solution was formed by combining equal volumes of 0.1 M EDOT (or TT) in acetonitrile and 0.1 M iodine in methanol as oxidant. The solution was used within 30 minutes of combining reagents. A 1 mL aliquot of this solution was pooled onto a PEDOT/PSS (or PTT/PSS) slide, prepared as in Example 1, that was resting on a spin coater chuck. After waiting 1 minute, the film was spun at 1500 rpm for 1 minute to remove the excess solution and dry the film. The film was left with an amber color. The film was baked at 100° C. for 2 minutes in air or nitrogen. The PTT/PSS films had a gray tint, and the PEDOT/PSS films had a blue-green tint. The thicknesses and conductivities of the films were measured. Small conductivity increases (less than a factor of 4) were achieved in PTT/PSS. The conductivity increase was greater than a factor of 100 in PEDOT/PSS using either TT or EDOT as an additive.

TABLE 20
Conductivity effect on PEDOT/PSS from exposure to EDOT monomer, oxidant,
and solvent

| | | | | Conductivity | |
|---|---|---|---|---|---|
| | | | Initial | After | Conductivity |
| | | | Conductivity | Treatment | Increase |
| Polymer | Monomer | Oxidant (Solvent) | (S/cm) | (S/cm) | Factor |
| PEDOT/PSS | EDOT | Iodine | | 35.4 | 367.9 |
| | | (MeOH/acetonitrile) | | | |
| PEDOT/PSS | TT | Iodine | | 26.96 | 103.1 |
| | | (MeOH/acetonitrile) | | | |
| PTT/PSS | EDOT | Iodine | | 0.059 | 3.9 |
| | | (MeOH/acetonitrile) | | | |
| PTT/PSS | TT | Iodine | | 0.015 | 1.0 |
| | | (MeOH/acetonitrile) | | | |

### Example 21

### Conductivity Enhancement from Multiple Exposures to Solvent, Oxidant, and Monomer

Repeated exposures of PEDOT/PSS to solvent/oxidant/additive were conducted to determine the effect on conductivity of multiple exposures. PEDOT/PSS films prepared as in Example 1 were utilized. A solution made from equal volumes of 0.1 M EDOT in acetonitrile and 0.1 M iodine in methanol was used for the conductivity enhancement exposures. The solution was used within 30 minutes of preparing it. In the first trial, a slide of PEDOT/PSS was placed on a spin coater chuck, and then 1 mL of the EDOT/iodine solution was pooled on the surface. After waiting 1 minute, the film was spun at 1500 rpm for 1 minute to remove the excess solution and dry the film. The film was baked at 100° C. for 2 minutes in air. The thickness and conductivity were measured. The process of exposure to the EDOT/iodine solution followed by spinning and baking was repeated. The conductivity was comparable to that achieved from a single exposure to 1:1 EDOT/iodine in acetonitrile/methanol. In the second trial, a slide of PEDOT/PSS was placed on a spin coater chuck, and then 1 mL of the EDOT/iodine solution was pooled on the surface. After waiting 1 minute, the film was spun at 1500 rpm for 1 minute to remove the excess solution and dry the film. The process of exposure to the EDOT/iodine solution followed by spinning dry was repeated. The film was baked at 100° C. for 2 minutes in air, and then the thickness and conductivity were measured. The conductivity of 33.2 S/cm was comparable to that achieved from a single exposure to 1:1 EDOT/iodine in acetonitrile/methanol. In the third trial, a slide of PEDOT/PSS was placed on a spin coater chuck, and then 1 mL of the EDOT/iodine solution was pooled on the surface. After waiting 1 minute, the film was spun at 1500 rpm for 1 minute to remove the excess solution and dry the film. The process of exposure to the EDOT/iodine solution followed by spinning dry was repeated twice. The film was baked at 100° C. for 2 minutes in air, and then the thickness and conductivity were measured. The conductivity of 46.6 S/cm was higher than that achieved from a single exposure to 1:1 EDOT/iodine in acetonitrile/methanol. In the fourth trial, a slide of PEDOT/PSS was placed on a spin coater chuck, and then 1 mL of the EDOT/iodine solution was pooled on the surface. After waiting 1 minute, the film was spun at 1500 rpm for 1 minute to remove the excess solution and dry the film. The process of exposure to the EDOT/iodine solution followed by spinning dry was repeated three times. The film was baked at 100° C. for 2 minutes in air, and then the thickness and conductivity were measured. The conductivity of 36.3 S/cm was comparable to that achieved from a single exposure to 1:1 EDOT/iodine in acetonitrile/methanol.

TABLE 21
Conductivity effect on PEDOT/PSS from exposure to
EDOT monomer, oxidant, and solvent

| | | | Conductivity | |
|---|---|---|---|---|
| Initial | | | After | Conductivity |
| Conductivity | Exposure | | Exposure | Increase |
| (S/cm) | conditions | Duration | (S/cm) | Factor |
| 0.1222 | EDOT/I₂/solvent | 1 min | | |
| | 100° C. bake | 5 min | 30 | 250 |
| | EDOT/I₂/solvent | 1 min | | |
| | 100° C. bake | 5 min | 36 | 300 |
| 0.1238 | EDOT/I₂/solvent | 1 min | | |
| | EDOT/I₂/solvent | 1 min | | |
| | 100° C. bake | 5 min | 33 | 270 |
| 0.1123 | EDOT/I₂/solvent | 1 min | | |
| | EDOT/I₂/solvent | 1 min | | |
| | EDOT/I₂/solvent | 1 min | | |
| | 100° C. bake | 5 min | 47 | 410 |
| 0.1165 | EDOT/I₂/solvent | 1 min | | |
| | EDOT/I₂/solvent | 1 min | | |
| | EDOT/I₂/solvent | 1 min | | |
| | EDOT/I₂/solvent | 1 min | | |
| | 100° C. bake | 5 min | 36 | 310 |

### Example 22

### Conductivity Enhancement of High Conductivity Orgacon PEDOT/PSS

Experiments were conducted to determine if solvent/additive post-exposure techniques would increase the conductivity of high conductivity Orgacon™ PEDOT/PSS films. Orgacon™ PEDOT/PSS dispersion from Agfa was used to cast films according to the procedure in Example 1. A solution was formed by combining equal volumes of 0.1 M EDOT in acetonitrile and 0.1 M iodine in methanol. The solution was used within 30 minutes of combining reagents. A 1 mL aliquot of this solution was pooled onto an Orgacon PEDOT/PSS film that was resting on a spin coater chuck. After waiting 1 minute, the film was spun at 1500 rpm for 1 minute to remove the excess solution and dry the film. The film was baked at 100° C. for 2 minutes in air or nitrogen. The thickness and conductivity of the film were measured. The conductivity increased by a factor of 380.9. A second solution was formed by combining appropriate volumes of 0.1 M EDOT in acetonitrile and 0.1 M iodine in ethylene glycol to give a 1:2 molar ratio of EDOT:iodine. The solution was used within 30 minutes of combining reagents. A 1 mL aliquot of this solution was pooled onto an Orgacon PEDOT/PSS film that was resting on a spin coater chuck. After waiting 1 minute, the film was spun at 1500 rpm for 1 minute to remove the excess solution and dry the film. The film was baked at 100° C. for 2 minutes in air or nitrogen. The thickness and conductivity of the film were measured. A conductivity of 313.5 S/cm—an increase of a factor of 639.7—was achieved.

TABLE 22
Conductivity effect on PEDOT/PSS from exposure to EDOT monomer, oxidant,
and solvent

| | | | | Conductivity | |
|---|---|---|---|---|---|
| | Initial | | | After | Conductivity |
| | Conductivity | EDOT:Iodine | | Exposure | Increase |
| Polymer | (S/cm) | Ratio | Solvent | (S/cm) | Factor |
| Baytron P | 0.096 | 1:1 | MeOH/acetonitrile | 35 | 370 |
| Orgacon | 0.67 | 1:1 | MeOH/acetonitrile | 250 | 380 |
| Orgacon | 0.49 | 1:2 | ethylene glycol/ | 310 | 640 |
| | | | acetonitrile | | |

### Example 23

### Effect of Conductivity Enhancement on PEDOT/PSS Containing Additives

Certain chemicals have been disclosed as additives to PEDOT/PSS dispersions such as surfactants to enhance wetting, epoxysilane adhesion promoters, polyhydroxy compounds such as sorbitol, and cosolvents. The additives in the Table 23 were added to PEDOT/PSS solutions. After two hours, the solutions were cast into films using the procedure in Example 1. The films were exposed to a 1:1 molar solution of EDOT:iodine in methanol/acetonitrile using the procedure in Example 21. The conductivity increased in all cases. A film containing 2.4 wt % sorbitol was exposed to 0.01 M iodine in water/acetonitrile yielding a factor of 1.2 conductivity increase to 239 S/cm.

TABLE 23
Conductivity effect on PEDOT/PSS from exposure to EDOT monomer,
oxidant, and solvent

| | Film | | Conductivity | |
|---|---|---|---|---|
| | Conductivity | | After | Conductivity |
| | with Additives | | Exposure | Increase |
| Additives | (S/cm) | Oxidant (Solvent) | (S/cm) | Factor |
| 1 wt % | 0.0058 | EDOT/iodine | 0.26 | 45 |
| epoxysilane, | | (MeOH/acetonitrile) | | |
| 1 wt % | 4.7 | EDOT/iodine | 36 | 7.7 |
| epoxysilane, | | (MeOH/acetonitrile) | | |
| 1 wt % sorbitol | | | | |
| 1 wt % | 25 | EDOT/iodine | 34 | 1.4 |
| epoxysilane, | | (MeOH/acetonitrile) | | |
| 9 wt % NMP, | | | | |
| 0.05% wt % Zonyl | | | | |
| FSO | | | | |
| 0.1 wt % | 23 | EDOT/iodine | 180 | 7.5 |
| epoxysilane, | | (MeOH/acetonitrile) | | |
| 1 wt % NMP | | | | |
| 1 wt % | 12 | EDOT/iodine | 110 | 8.8 |
| epoxysilane, 8 wt % | | (MeOH/acetonitrile) | | |
| isopropanol, | | | | |
| 5 wt % sorbitol | | | | |
| 5 wt % sorbitol | 140^{a} | EDOT/iodine | 270^{a} | 2.0 |
| | | (MeOH/acetonitrile) | | |
| 2.4 wt % sorbitol | 200^{a} | 0.01 M iodine | 240^{a} | 1.2 |
| | | (water/acetonitrile) | | |

^{a}Orgacon PEDOT/PSS.

### Experiment 24

### Effect of Solvent Addition on the Conductivity of PTT/PSS Film

A dispersion of poly(thieno(3,4-b)thiophene):poly(styrene sulfonic acid) (PTT/PSS), Dispersion 1A, was prepared following the procedure described in U.S. patent application Ser. No. 10/755,426, filed Jan. 12, 2004; hereby incorporated by reference, and starting with a PSS:TT ratio of 2.55:1. Dispersion 1B was then prepared by adding 19.3 mg of N-methyl-2-pyrrolidinone (NMP) to 0.569 g of Dispersion 1A;

Dispersion 1C was prepared by adding 14.5 mg of sorbitol (from Aldrich) into 0.565 g of Dispersion 1A. Films 1A, 1B, and 1C were then prepared by drop-casting 0.5 mL of Dispersions 1A, 1B and 1C onto 1″×1″ glass substrates, respectively. The dispersions were dried overnight in air. After the film was dried, the conductivities of the films were measured using a four-point probe before and after annealing at 200° C. for 20 min in N2.

Conductivities were summarized in Table 24. The addition of NMP in PTT/PSS increases the conductivity of the film by 2-3 times, and addition of sorbitol increases the conductivity by a factor of 10.

TABLE 24
Conductivities of PTT/PSS films with additives in the dispersions.

| | Additive | Film thickness | Conductivity as | Conductivity after |
|---|---|---|---|---|
| Film | used | (nm) | cast (S/cm) | annealing (S/cm) |
| 1A | none | 6300 | 6.3 × 10⁻³ | 2.5 × 10⁻² |
| 1B | NMP | 6355 | 2.0 × 10⁻² | 6.8 × 10⁻² |
| 1C | sorbitol | 6596 | 1.8 × 10⁻³ | 2.6 × 10⁻¹ |

### Example 25

### Effect on Solvent Addition on the Conductivity of PTT/PSS and PEDOT/PSS Films

A dispersion of PTT/PSS, Dispersion 2A, was prepared following the procedure described in U.S. patent application Ser. No. 10/755,426, filed Jan. 12, 2004,, and starting with a PSS:TT ratio of 4.73:1. Dispersion 2B was prepared by adding 25.3 mg of sorbitol (from Aldrich) into 0.5 g of Dispersion 2A. In comparison, Baytron P® V4071 PEDOT/PSS dispersion with a PSS: EDOT ratio of 2.5:1 (From Bayer) was also tested. Dispersion 2C was prepared by adding 44.9 mg of sorbitol into 0.900 g of Baytron P® V4071 PEDOT/PSS dispersion. Dispersion 2D was prepared by adding 0.25 g of NMP into 5.0 g of Baytron P® V4071 PEDOT/PSS dispersion. Films were then prepared by either spin coating or drop casting onto glass substrates. And conductivities of the films were then measured before and after annealing in nitrogen. The results are summarized in Table 25.

TABLE 25
Conductivities of PTT/PSS and PEDOT/PSS films with
additives in the dispersions.

| | | Film | Conductivity | |
|---|---|---|---|---|
| | Additive | thickness | as | Conductivity after |
| Dispersion | used | (nm) | cast (S/cm) | annealing (S/cm) |
| 2A (PTT/PSS) | none | 6440 | 7.3 × 10⁻³ | 5.3 × 10⁻² |
| | | (drop cast) | | (200° C., 5 min) |
| 2A (PTT/PSS) | none | 78 | 1.1 × 10⁻³ | 6.1 × 10⁻³ |
| | | (spun) | | (200° C., 5 min) |
| 2B (PTT/PSS) | sorbitol | 69 | 3.3 × 10⁻³ | 1.4 × 10⁻¹ |
| | | (spun) | | (200° C., 4 min) |
| Baytron P ® | none | 6500 | 6.3 × 10⁻² | 1.5 × 10⁻¹ |
| V4071 | | (drop cast) | | (160° C., 15 min) |
| (PEDOT/PSS) | | | | |
| Baytron P ® | none | 187 | 5.5 × 10⁻² | 1.8 × 10⁻¹ |
| V4071 | | (spun) | | (200° C., 5 min) |
| (PEDOT/PSS) | | | | |
| 2C | sorbitol | 8288 | 3.0 × 10⁻³ | 3.2 × 10⁺¹ |
| (PEDOT/PSS) | | (drop cast) | | (200° C., 10 min) |
| 2C | sorbitol | 225 | 2.9 × 10⁻³ | 5.9 × 10⁺¹ |
| (PEDOT/PSS) | | (spun) | | (200° C., 4 min) |
| 2D | NMP | 146 | 2.7 × 10⁺¹ | 2.2 × 10⁺¹ |
| (PEDOT/PSS) | | (spun) | | |

1) A process for increasing the electrical conductivity of a polymeric film comprising:
contacting the film with a solution comprising at least one organic solvent, and;
removing substantially all of the solvent thereby producing a film having increased electrical conductivity.

2) The process of claim 1 wherein the polymeric film is a doped, conjugated polymer and said removing comprises at least one process from the group consisting of rinsing, heating and vacuuming.

3) The process of claim 1 wherein the polymeric film comprises poly(3,4-ethylenedioxythiophene)/polystyrene sulfonic acid.

4) The process of claim 3 wherein the conductivity of the film is increased to greater than about 100 S/cm.

5) The process of claim 1 wherein the film having increased electrical conductivity is also transparent in the visible spectrum.

6) The process of claim 1 wherein the solvent comprises at least one member selected from the group consisting of ethylene glycol, formamide, 2,2,3,3-tetrafluoro-1-propanol, ethylene carbonate, acetic acid, dimethylsulfoxide (DMSO), pyridine, N-methylpyrrolidinone (NMP), N,N-dimethyacetamide (DMAc), acetonitrile, tetrahydrofuran (THF), isopropanol, and methanol.

7) The process of claim 1 wherein the solvent further comprises at least one oxidant selected from the group consisting of iodine, bromine, FeCl₃, FeBr₃, Fe₂(SO₄)₃, iron(III) p-toluenesulfonate, ammonium persulfate, AsF₅, and salts or acids of BF₄⁻, SbF₆⁻, PF₆⁻.

8) The process of claim 1 wherein the solvent further comprises at least one oxidant and at least one monomer selected from the group consisting of 3,4-ethylenedioxythiophene, thieno[3,4-b]thiophene, thiophene, 3-alkylthiophenes, and 3,4-dialkylthiophenes.

9) The process of claim 1 wherein the polymeric film comprises at least one member selected from the group consisting of antistatic coatings, electrodes for capacitors, hole injection/transport layer or electrodes for light-emitting diodes or photovoltaic devices, optically transparent conductors for display devices, electromagnetic radiation shielding, and wires for microelectronics.

10) The process of claim 1 wherein the solvent comprises at least one water soluble solvent.

11) The process of claim 10 wherein the solvent is present in at least about 1.0 wt. % of the solution.

12) A process for treating a polymeric film comprising:
contacting the film with a solution comprising at least one organic solvent, and;
removing substantially all of the solvent; wherein the conductivity of the polymeric film is not substantially increased.

13) The process of claim 12 wherein the polymeric film comprises poly(thienothiophene).

14) The process of claim 12 wherein the polymeric film further comprises at least one member selected from the group consisting of polystyrene sulfonic acid, aromatic polysulfonic acid, fluorinated polysulfonic acid, and poly(sulfonic acid).

15) The process of claim 11 wherein the polymeric film comprises at least one member selected from the group consisting of substituted and unsubstituted polythiophenes, polypyrroles, polyselenophenes, polythienothiophenes, poly(para-phenylenevinylenes), poly(para-phenylenes), poly(para-phenyleneethynylenes), polyanilines, polyazines, poly(para-phenylene sulfide), polyfurans, polyacetylenes, combinations thereof, and copolymers thereof.

16) The process of claim 11 wherein the polymer film is formed a process comprising: combining at least one solvent with a dispersion of the polymer, applying the dispersion onto a substrate to form a film, and drying the applied film.

17) The process of claim 11 wherein the conductivity of the polymeric film does not increase by more than about 100 times.
